(19) United States
(12) Patent Application Publication
(10) Pub. No.: US 2026/0003185 A1
(43) Pub. Date: Jan. 1, 2026

(54) DISPLAY DEVICE

(71) Applicants: InnoLux Corporation, Miao-Li County (TW); CARUX TECHNOLOGY PTE. LTD., APERIA (SG)

(72) Inventors: Yu-Chia HUANG, Miao-Li County (TW); Yu-Hsuan HSIAO, Tainan (Tainan Science Park) (TW); Tsung-Han TSAI, Miao-Li County (TW); Yu-Chien KAO, Tainan (Tainan Science Park) (TW)

(21) Appl. No.: 19/220,754

(22) Filed: May 28, 2025

(30) Foreign Application Priority Data
Jun. 27, 2024 (CN) 202410846154.6

(51) Int. Cl. G02B 27/01; B60K 35/23; G02F 1/13357

(52) U.S. Cl. CPC G02B 27/0101; B60K 35/23; G02F 1/133606; G02F 1/133611; B60K 2360/33; G02B 2027/0118

(57) ABSTRACT

A display device is provided. The display device is disposed under a windshield. The bottom of the windshield has a first arc-shaped edge. The display device includes a display panel to project a display image onto the windshield. The display panel is flat. The display panel has a second arc-shaped edge adjacent to the first arc-shaped edge. The first arc-shaped edge has a first radius of curvature, represented by Rs1. The second arc-shaped edge has a second radius of curvature, represented by Rd1. The ratio of the first radius of curvature to the second radius of curvature is greater than or equal to 0.1 and less than or equal to 10.

### CROSS REFERENCE TO RELATED APPLICATIONS

This application claims priority of China Patent Application No. 202410846154.6, filed on Jun. 27, 2024, the entirety of which is incorporated by reference herein.

### BACKGROUND

### Technical Field

The present disclosure relates to a display device, and in particular it relates to a display device with arc-shaped edges.

### Description of the Related Art

A traditional rectangular display used in a car does not match the curved windshield, and this results in poor utilization of the space inside the car. Also, the distance projected from each position on a rectangular display onto the windshield is not the same, subsequently making it difficult to correct for distortions in the image.

### SUMMARY

In accordance with one embodiment of the present disclosure, a display device disposed under a windshield is provided. The bottom of the windshield has a first arc-shaped edge. The display device includes a display panel to project a display image onto the windshield. The display panel is flat. The display panel has a second arc-shaped edge adjacent to the first arc-shaped edge. The first arc-shaped edge has a first radius of curvature, represented by Rs1. The second arc-shaped edge has a second radius of curvature, represented by Rd1. The ratio of the first radius of curvature to the second radius of curvature is greater than or equal to 0.1 and less than or equal to 10.

### BRIEF DESCRIPTION OF THE DRAWINGS

The disclosure can be more fully understood from the following detailed description when read with the accompanying figures. It is worth noting that in accordance with standard practice in the industry, various features are not drawn to scale. In fact, the dimensions of the various features may be arbitrarily increased or reduced for clarity of discussion.

FIG. 1 shows a schematic diagram of a display device and windshield in accordance with one embodiment of the present disclosure;

FIG. 2 shows a side view of a display device and windshield in accordance with one embodiment of the present disclosure;

FIG. 3 shows an enlarged view of part of a display panel in accordance with one embodiment of the present disclosure;

FIG. 4 shows a three-dimensional schematic diagram of a display device in accordance with one embodiment of the present disclosure;

FIG. 5 shows a schematic cross-sectional view of a display device in accordance with one embodiment of the present disclosure;

FIG. 6 shows a schematic cross-sectional view of a display device in accordance with one embodiment of the present disclosure;

FIG. 7A shows a schematic diagram of a light-emitting area of a backlight module in accordance with one embodiment of the present disclosure;

FIG. 7B shows a schematic cross-sectional view of a light-emitting area of a backlight module in accordance with one embodiment of the present disclosure;

FIGS. 8A-8F show schematic diagrams of different shapes of a light-emitting area of a backlight module in accordance with one embodiment of the present disclosure;

FIGS. 9A-9E show schematic diagrams of pixel unit arrangement with scan line layout in accordance with one embodiment of the present disclosure;

FIGS. 10A-10C show schematic diagrams of placement of an electronic unit in accordance with one embodiment of the present disclosure;

FIGS. 11A-11D show schematic diagrams of configuration of scan lines and data lines in accordance with one embodiment of the present disclosure;

FIG. 12 shows a schematic diagram of pixel unit arrangement with scan line layout in accordance with one embodiment of the present disclosure;

FIG. 13 shows a schematic diagram of pixel unit arrangement in accordance with one embodiment of the present disclosure; and

FIG. 14 shows a schematic cross-sectional view of a display device in accordance with one embodiment of the present disclosure.

### DETAILED DESCRIPTION

The following description lists various embodiments of this disclosure to introduce the basic concepts of this case, and is not intended to limit the content of this case. The actual scope of the invention should be defined according to the scope of the patent application. Reference will now be made in detail to exemplary embodiments of the present disclosure, examples of which are illustrated in the accompanying drawings. Whenever possible, the same reference numbers are used in the drawings and descriptions to refer to the same or similar parts.

Throughout this disclosure and the appended claims, certain words are used to refer to specific components. Those skilled in the art will appreciate that the device manufacturers may refer to the same components by different names. This article is not intended to differentiate between components that have the same functionality but different names. In the following description and claims, the words “comprise”, “include” and “contain” are open-ended words, and therefore they should be interpreted to mean “comprising but not limited to . . . ”

The directional terms mentioned in this article, such as: “up”, “down”, “front”, “back”, “left”, “right”, etc., are only for reference to the directions of the accompanying drawings. The directional terms in this paper are used to define the relative positions of the illustrated components, and are not intended to limit the disclosure. In the drawings, each figure illustrates the general features of methods, structures, and/or materials used in particular embodiments. However, these drawings should not be interpreted as defining or limiting the scope or nature encompassed by these embodiments. For example, the relative sizes, thicknesses, and locations of the different layers, regions, and/or structures may be shrunken or enlarged for clarity.

In this paper, one structure (or layer, or component, or substrate) located on/above another structure (or layer, or component, or substrate) may mean that the two structures are directly connected, or the two structures are adjacent but not directly connected. Indirect connection means that there is at least one intermediary structure between two structures. The lower surface of upper structure is adjacent to or directly connected to the upper surface of the intermediary structure. The upper surface of the lower structure is adjacent to or directly connected to the lower surface of the intermediate structure. The intermediary structure may be a single-layer/multi-layer physical structure, or a non-physical structure (there is no limit). In this disclosure, when a structure is disposed “on” another structure, it may mean that the structure is “directly” on the other structure, or that the structure is “indirectly” on the other structure (that is, between the two structures, at least one other structure is also sandwiched.

The terms “about”, “substantially” or “roughly” are generally interpreted to mean an offset within 20% of a given value or range, or to mean an offset within 5%, 3%, 2%, 1% or 0.5% of a given value or range.

Furthermore, any two numerical values or directions used for comparison may have certain errors. If the first value is equal to the second value, it implies that there may be a tolerable error difference about 10%. If a first direction is perpendicular or approximately perpendicular to a second direction, the angle between the first direction and the second direction may be 80-100 degrees. If the first direction is parallel or substantially parallel to the second direction, the angle between the first direction and the second direction may be 0-10 degrees.

The ordinal numbers used in the description and claims, such as “first”, “second”, etc., are used for identification between components. They do not imply the existence of a component with the previous ordinal number. Such ordinal numbers do not represent the order of the components, or the order of manufacturing procedures. These ordinal numbers are used to clearly distinguish two components with the same naming. The ordinal numbers given to the components in the claims may be different from the ordinal numbers given to the components in the description. Accordingly, the first component in the description may be the second component in the claim.

In the disclosure, descriptions like “a given range is from a first value to a second value” or “a given range falls within the range between a first value and a second value” indicate that the given range includes the first value, the second value, and other values between them.

It should be understood that in the exemplary embodiments of the disclosure, the depth, thickness, width, or height of each component, or the spacing or distance between components may be measured by an optical microscope (OM), a scanning electron microscope (SEM), a film thickness measurement device (α-step), or an ellipsometer. In some exemplary embodiments, a cross-sectional structural image of a component may be captured by a scanning electron microscope, which also measures the depth, thickness, width or height of each component, or the spacing or distance between components.

An electronic device may include an imaging device, a laminated device, a display device, a backlight device, an antenna device, an assembled device, a touch display, a curved display, or a free shape display, but not limited thereto. The electronic device may use display media like liquid crystal, light-emitting diodes, fluorescence, phosphor, or any other suitable display media, or a combination of the above, but it is not limited thereto. The light-emitting diode may include, for example, organic light-emitting diodes (OLEDs), submillimeter light-emitting diodes (mini LEDs), micro light-emitting diodes (micro LEDs) or quantum dot light-emitting diodes (quantum dots, QD, which can be, for example, QLED, QDLED) or other suitable materials or any combination of the above materials, but is not limited thereto. A display device may be a non-self-luminous display device or a self-luminous display device. An antenna device may be a liquid-crystal type antenna device or a non-liquid-crystal type antenna device. A sensing device may use sensors sensing capacitance, light, heat energy or ultrasonic waves, but it is not limited thereto. An assembled device may be an assembled display device or an assembled antenna device, but it is not limited thereto. It should be noted that the electronic device can be any combination of the above, but it is not limited thereto. The electronic device may be a bendable or flexible electronic device. It should be noted that the electronic device can be any combination of the above, but it is not limited thereto. In addition, the shape of the electronic device may be a rectangular shape, a circular shape, a polygonal shape, a shape with curved edges, or other suitable shapes. The electronic device may have peripheral systems such as a driving system, a control system, a light source system, a structural system, etc., to form the display device, antenna device or assembled device.

It should be noted that in the embodiments shown below, features in several different embodiments may be replaced, reorganized, or combined without departing from the spirit of the present disclosure. Features in various embodiments may be combined as long as they do not violate the spirit of the disclosure or conflict with each other.

Unless otherwise defined, all terms (including technical and scientific terms) used herein have the same meaning as commonly understood by one of ordinary skill in the art. It is understood that these terms, such as those defined in commonly used dictionaries, should be interpreted to have a meaning consistent with the relevant technology and the background or context of the present disclosure, and should not be interpreted in an idealized or overly formal manner (unless otherwise defined).

In addition, the word “adjacent” in the description and claims, for example, is used to describe mutual proximity and does not necessarily mean that they are in contact with each other.

Furthermore, “disposed on” and other similar descriptions in this disclosure indicate the relative positions of objects, and do not limit to a physical contact between the objects, unless there are special limitations. Furthermore, when the present disclosure describe multiple functions, and the word “or” is used in listing the functions, it means that the functions can exist independently, but it does not exclude that multiple functions may exist at the same time.

In addition, words such as “electrically connected” or “coupled” in the description and claims not only refer to a direct electrical connection between the different objects, but also refer to an indirect electrical connection between the different objects. Electrical connection includes direct electrical connection, indirect electrical connection, or wireless communication between the different objects.

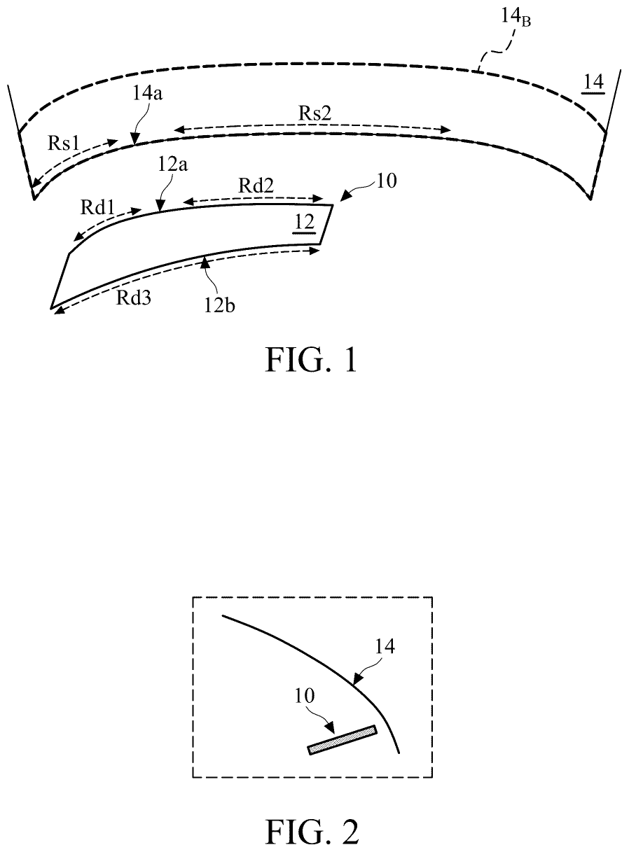

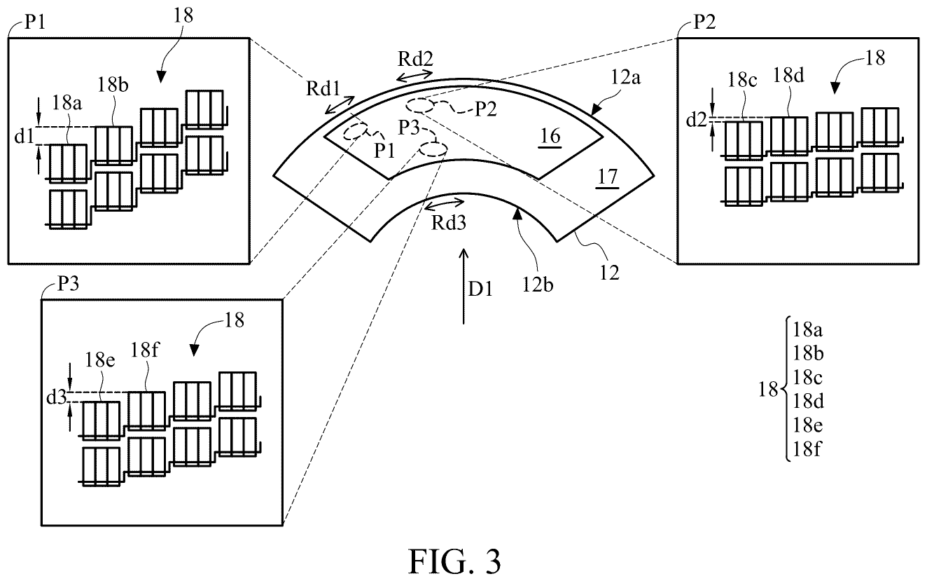

In this present disclosure, when “or” is used as a connective word between multiple elements, unless otherwise stated, the expressions of “and” and “or” are included. Referring to FIGS. 1 and 2, in accordance with one embodiment of the present disclosure, a display device 10 is provided. FIG. 1 is a schematic diagram of the display device 10 and the windshield 14. FIG. 2 is a side view of the display device 10 and the windshield 14.

As shown in FIG. 1, the display device 10 is disposed under the windshield 14. The display device 10 includes a display panel 12 to project a display image onto the windshield 14. The bottom 14B of the windshield 14 has a first arc-shaped edge 14a. The display panel 12 has a second arc-shaped edge 12a adjacent to the first arc-shaped edge 14a. The first arc-shaped edge 14a has a first radius of curvature Rs1. The second arc-shaped edge 12a has a second radius of curvature Rd1. It is worth noting that the ratio of the first radius of curvature Rs1 to the second radius of curvature Rd1 may be greater than or equal to 0.1 and less than or equal to 10. For example, the ratio of the first radius of curvature Rs1 to the second radius of curvature Rd1 may be 0.1, 0.5, 0.7, 0.9, 1.1, 1.3, 1.5, 2, 5, or 10, etc., any of the above values or any range between the above values.

The second arc-shaped edge 12a may have, for example, two or more radii of curvature, but it is not limited thereto. As shown in FIG. 1, the second arc-shaped edge 12a further has a third radius of curvature Rd2 that is different from the second radius of curvature Rd1. The first radius of curvature Rs1, the second radius of curvature Rd1 and the third radius of curvature Rd2 comply with formula (I):

$$\vert ( Rs 1 / Rd 1 ) - 1 \vert < \vert ( Rs 1 / Rd 2 ) - 1 \vert . \qquad ( I )$$

It can be seen in formula (I) that the match between the first radius of curvature Rs1 and the second radius of curvature Rd1 is higher than the match between the first radius of curvature Rs1 and the third radius of curvature Rd2. In accordance with some embodiments, the second radius of curvature Rd1 and the third radius of curvature Rd2 may be different.

As shown in FIG. 1, the display panel 12 further has a third arc-shaped edge 12b corresponding to the second arc-shaped edge 12a. The third arc-shaped edge 12b has a fourth radius of curvature Rd3, but it is not limited thereto. In accordance with some embodiments, the third arc-shaped edge 12b has more than two radii of curvature. The first radius of curvature Rs1, the second radius of curvature Rd1 and the fourth radius of curvature Rd3 comply with formula (II):

$$\vert ( Rs 1 / Rd 1 ) - 1 \vert ≦ \vert ( Rs 1 / Rd 3 ) - 1 \vert . \qquad ( II )$$

It can be seen in formula (II) that the match between the first radius of curvature Rs1 and the second radius of curvature Rd1 is higher than or equal to the match between the first radius of curvature Rs1 and the fourth radius of curvature Rd3. In accordance with some embodiments, the second radius of curvature Rd1 and the fourth radius of curvature Rd3 may be the same. In accordance with some embodiments, the second radius of curvature Rd1 and the fourth radius of curvature Rd3 may be different.

In accordance with some embodiments, the third radius of curvature Rd2 and the fourth radius of curvature Rd3 may be the same. In accordance with some embodiments, the third radius of curvature Rd2 and the fourth radius of curvature Rd3 may be different.

As shown in FIG. 1, the first arc-shaped edge 14a further has a fifth radius of curvature Rs2 that is different from the first radius of curvature Rs1. The second radius of curvature Rd1, the third radius of curvature Rd2 and the fifth radius of curvature Rs2 comply with formula (III):

$$\vert ( Rs 2 / Rd 2 ) - 1 \vert < \vert ( Rs 2 / Rd 1 ) - 1 \vert \qquad ( III )$$

It can be seen in formula (III) that the match between the fifth radius of curvature Rs2 and the third radius of curvature Rd2 is higher than the match between the fifth radius of curvature Rs2 and the second radius of curvature Rd1.

As shown in FIG. 1, the third radius of curvature Rd2, the fourth radius of curvature Rd3 and the fifth radius of curvature Rs2 comply with formula (IV):

$$\vert ( Rs 2 / Rd 2 ) - 1 \vert ≦ \vert ( Rs 2 / Rd 3 ) - 1 \vert \qquad ( IV )$$

It can be seen in formula (IV) that the match between the fifth radius of curvature Rs2 and the third radius of curvature Rd2 is higher than or equal to the match between the fifth radius of curvature Rs2 and the fourth radius of curvature Rd3.

In accordance with some embodiments, the first radius of curvature Rs1, the second radius of curvature Rd1, the third radius of curvature Rd2, the fourth radius of curvature Rd3 and the fifth radius of curvature Rs2 may be greater than 0. In accordance with some embodiments, the edge corresponding to the second arc-shaped edge 12a is a straight edge.

As shown in FIG. 2, the display panel 12 may be flat.

As shown in FIGS. 1 and 2, the display device 10 may be a flat display with a curved profile.

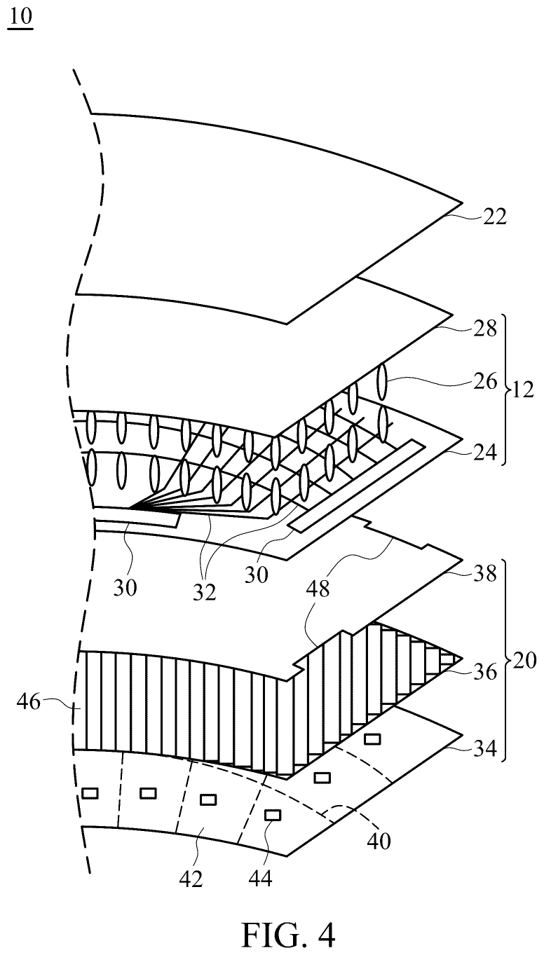

Referring to FIG. 3, the arrangement of pixel units corresponding to different curvature radii on the arc-shaped edges in the display panel 12 is further described.

As shown in FIG. 3, the display panel 12 has the second arc-shaped edge 12a and the third arc-shaped edge 12b corresponding to each other. The second arc-shaped edge 12a has the second curvature radius Rd1 and the third curvature radius Rd2. The third arc-shaped edge 12b has the fourth radius of curvature Rd3. The relationship between the curvature radii of the same edge of the display panel 12 and the relationship between the curvature radii of different edges of the display panel 12 can be referred to the description in FIG. 1 and will not be described again here.

The display panel 12 includes a display area 16 and a peripheral area 17. The peripheral area 17 has the second arc-shaped edge 12a and the third arc-shaped edge 12b. The third arc-shaped edge 12b corresponds to the second arc-shaped edge 12a. The display area 16 includes a plurality of pixel units 18. The multiple pixel units 18 includes, for example, a first portion P1, a second portion P2, and a third portion P3. The first portion P1 includes, for example, a first pixel unit 18a and a second pixel unit 18b adjacent to the first pixel unit 18a. The first pixel unit 18a and the second pixel unit 18b are adjacent to the second arc-shaped edge 12a having the second radius of curvature Rd1. Also, the first pixel unit 18a and the second pixel unit 18b have a first displacement distance d1 in a first direction D1. The first displacement distance d1 may be greater than 0.

The second portion P2 includes, for example, a third pixel unit 18c and a fourth pixel unit 18d adjacent to the third pixel unit 18c. The third pixel unit 18c and the fourth pixel unit 18d are adjacent to the second arc-shaped edge 12a having the third radius of curvature Rd2. Also, the third pixel unit 18c and the fourth pixel unit 18d have a second displacement distance d2 in the first direction D1. The second displacement distance d2 may be greater than 0. In accordance with some embodiments, the second displacement distance d2 may be different from the first displacement distance d1.

The third portion P3 includes, for example, a fifth pixel unit 18e and a sixth pixel unit 18f adjacent to the fifth pixel unit 18e. The fifth pixel unit 18e and the sixth pixel unit 18f are adjacent to the third arc-shaped edge 12b having the fourth radius of curvature Rd3. Also, the fifth pixel unit 18e and the sixth pixel unit 18f have a third displacement distance d3 in the first direction D1. The third displacement distance d3 may be greater than 0. In accordance with some embodiments, the third displacement distance d3 may be different from the first displacement distance d1. In accordance with some embodiments, the second displacement distance d2 and the third displacement distance d3 may be the same. In accordance with some embodiments, the second displacement distance d2 may be different from the third displacement distance d3.

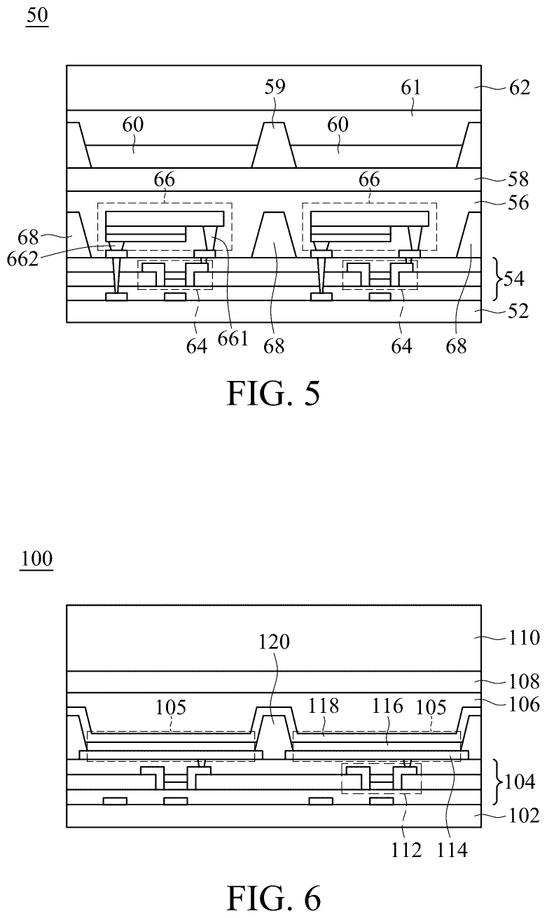

Referring to FIG. 4, in accordance with one embodiment of the present disclosure, a three-dimensional schematic diagram of the display device 10 is provided.

As shown in FIG. 4, the display device 10 includes a display panel 12, a backlight module 20 and a cover layer 22. The display panel 12 and the backlight module 20 are arranged corresponding to each other. The cover layer 22 is provided on the display panel 12.

The display panel 12 includes, for example, a first substrate 24, a liquid-crystal layer 26, and a second substrate 28. The first substrate 24 includes driving units 30 and signal lines 32, such as data lines and scan lines, connecting the driving units 30. The placement position of the driving units 30 on the first substrate 24 and the arrangement of the signal lines 32 will be described later.

The backlight module 20 includes, for example, a light source 34, a brightness enhancement film (BEF) 36, and a diffusion film 38. As shown in FIG. 4, the light source 34 includes a plurality of areas, such as light-emitting areas 42, defined by a range surrounded by a light confinement structure 40. Each light-emitting area 42 has at least one light-emitting unit 44. In accordance with some embodiments, the shape of the light-emitting area 42 surrounded by the light confinement structure 40 may be non-rectangular, for example, two corresponding edges of the light-emitting area have different widths. The shape of the light-emitting area 42 can be designed to match the upper curved display panel to improve light extraction efficiency. The shape design of the light-emitting area 42 will be described later. The light-emitting unit 44 may include a light-emitting diode (LED), but it is not limited thereto. The light confinement structure 40 may be a retaining wall, reflective glue, groove, protrusion, low-refractive-index material or other structures with light confinement function. As shown in FIG. 4, the light source 34 is a direct backlight source. The brightness enhancement film (BEF) 36 further includes microstructures 46 disposed thereon, for example, a plurality of parallel prism strips. The microstructures 46 (e.g., parallel prism strips) can be arranged in up and down (vertical) or left and right (horizontal) directions, and the angle of arrangement can be between about ±10 degrees. In addition, the edges of the diffusion film 38 may be formed with, for example, concave structures 48 (as shown in FIG. 4) or convex structures (not shown) to facilitate component fixation. In accordance with some embodiments, the backlight module 20 may be of local dimming type.

In accordance with the stack structure shown in FIG. 4, the display device 10 is a non-self-luminous liquid-crystal display (LCD), but it is not limited thereto. The present disclosure may also be applied to other types of displays, such as a self-luminous micro light-emitting diode display (micro LED) or an organic light-emitting diode display (OLED).

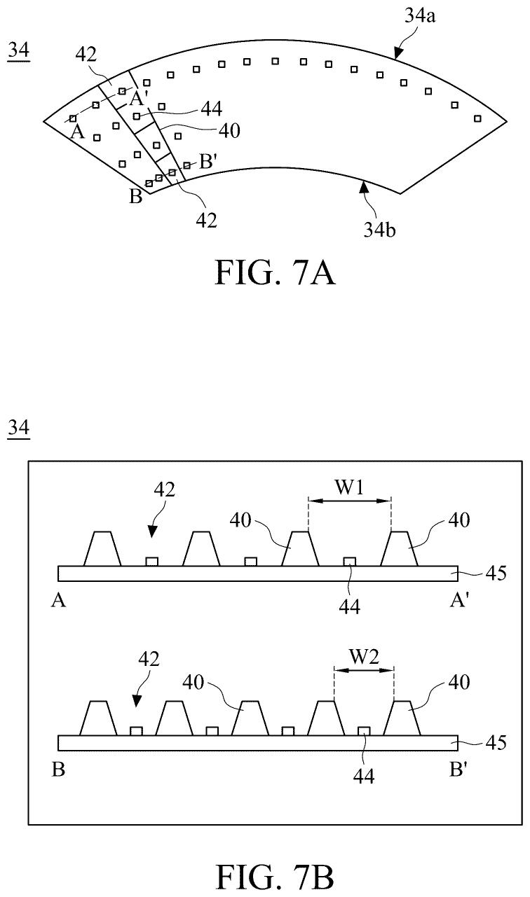

Referring to FIG. 5, in accordance with one embodiment of the present disclosure, a schematic cross-sectional view of a display device 50 is provided.

As shown in FIG. 5, the display device 50 includes, for example, a substrate 52, a circuit layer 54, a light-emitting unit 66, a light confinement structure 68, an insulation layer 56, an intermediate layer (or adhesive layer) 58, a light-shielding structure 59, a light conversion structure 60, an insulation layer 61 and a cover layer 62. In accordance with some embodiments, the display device 50 may not be provided with the intermediate layer (or adhesive layer) 58, the light conversion structure 60 or/and the insulation layer 61. In accordance with some embodiments, the display device 50 may not be provided with the light confinement structure 68. The circuit layer 54 includes thin-film transistors (TFTs) 64, signal lines, etc., but it is not limited thereto. The signal lines may be, for example, scan lines, data lines, power lines, emission lines, ground lines, or other suitable conductive lines. The light-emitting unit 66 includes pads 661 and 662, which can be electrically connected to different positions of the circuit layer 54 respectively. The thin-film transistor 64 is electrically connected to the pad 661. The light confinement structure 68 is disposed between adjacent light-emitting units 66. In accordance with some embodiments, the light confinement structure 68 surrounds the light-emitting unit 66. The insulation layer 56 is disposed on the light-emitting units 66 and the light confinement structure 68. The intermediate layer (or adhesive layer) 58 may be disposed on the insulation layer 56. The light conversion structure 60 is disposed on the intermediate layer (or adhesive layer) 58 and is disposed corresponding to the light-emitting units 66. The light conversion structure 60 includes color filters, quantum dots, or other materials that convert light, or a combination thereof. The light-shielding structure 59 is disposed between adjacent light conversion structures 60. The light-shielding structure 59 may be, for example, a black matrix, an area where at least two light conversion structures 60 overlap, or other light-shielding materials and combinations. The insulation layer 61 is disposed on the light-shielding structure 59 and the light conversion structure 60. The cover layer 62 is provided on the insulation layer 61. In accordance with some embodiments, the light-emitting unit 66 may include a light-emitting diode (LED). In accordance with some embodiments, the color of the light-emitting units 66 surrounded by adjacent light confinement structures 68 may be the same. In accordance with some embodiments, the color of the light-emitting units 66 surrounded by adjacent light confinement structures 68 may be different.

In accordance with the stack structure shown in FIG. 5, the display device 50 is a micro light-emitting diode display (micro LED), but it is not limited thereto. The present disclosure may also be applied to other types of displays, such as a liquid-crystal display (LCD) or an organic light-emitting diode display (OLED).

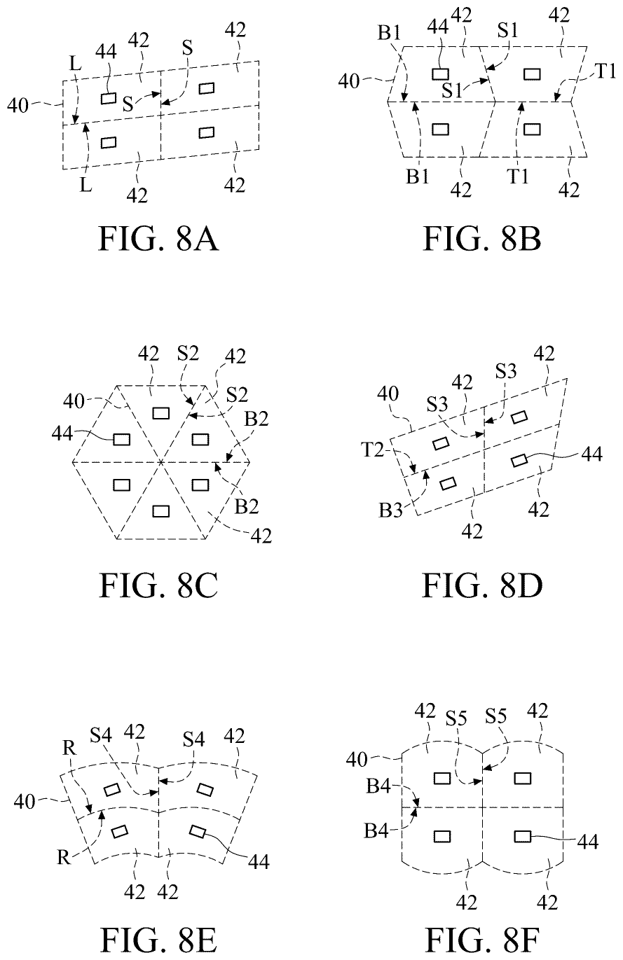

Referring to FIG. 6, in accordance with one embodiment of the present disclosure, a schematic cross-sectional view of a display device 100 is provided.

As shown in FIG. 6, the display device 100 includes, for example, a substrate 102, a circuit layer 104, a light-emitting unit 105, a light confinement structure 120, an insulation layer 106, an intermediate layer (or adhesive layer) 108 and a cover layer 110. The circuit layer 104 includes thin-film transistors (TFTs) 112, signal lines, etc., but it is not limited thereto. The light-emitting unit 105 includes a first electrode 114, a light-emitting layer 116, and a second electrode 118. The thin-film transistor (TFT) 112 is electrically connected to the first electrode 114. The light confinement structure 120 is disposed between adjacent light-emitting units 105. The light confinement structure 120 may be a pixel definition layer (PDL). The insulation layer 106 is disposed on the light-emitting units 105 and the light confinement structure 120. The intermediate layer (or adhesive layer) 108 may be disposed on the insulation layer 106. The cover layer 110 is disposed on the intermediate layer (or adhesive layer) 108. In accordance with some embodiments, the display device 100 may be selectively provided with a light conversion structure and a light-shielding structure. For example, the light conversion structure and the light-shielding structure may be disposed between the intermediate layer (or adhesive layer) 108 and the cover layer 110, but they are not limited thereto.

In accordance with the stack structure shown in FIG. 6, the display device 100 is an organic light-emitting diode display (OLED), but it is not limited thereto. The present disclosure may also be applied to other types of displays, such as a liquid-crystal display (LCD) or a micro light-emitting diode display (micro LED).

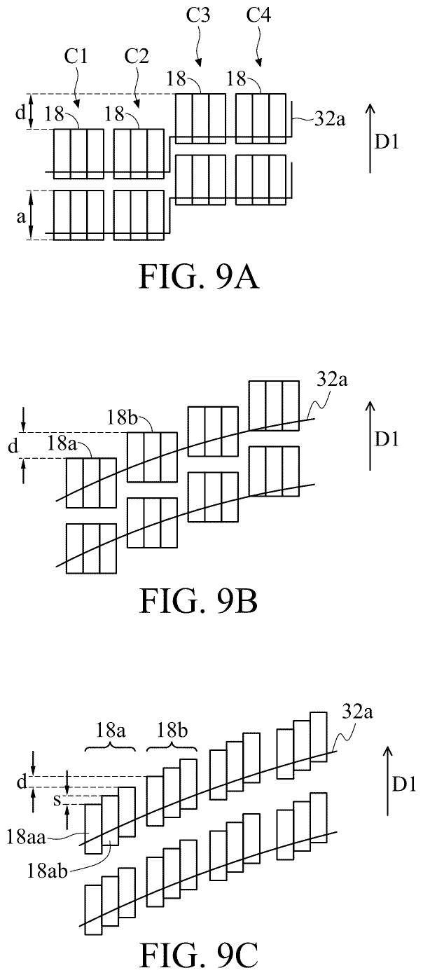

Referring to FIGS. 7A and 7B, the shape and structure of the light-emitting area of the backlight module are further illustrated. FIG. 7A is a schematic diagram of the light-emitting area of the backlight module. FIG. 7B is a schematic cross-sectional view of the light-emitting area of the backlight module.

As shown in FIG. 7A, the light source 34 includes a plurality of light-emitting areas 42 defined by a range surrounded by the light confinement structure 40. The light-emitting areas 42 extend from the upper edge 34a to the lower edge 34b of the light source 34. Each light-emitting area 42 has at least one light-emitting unit 44. In accordance with some embodiments, when the display panel above the light source 34 is designed as a curved display panel, in order to improve the light extraction efficiency and reduce light leakage, the shape of the light-emitting area 42 can be designed to be, for example, a non-rectangular shape with a narrow bottom and a wide top, as shown in FIG. 7A.

FIG. 7B is a schematic cross-sectional view taken along the A-A′ and B-B′ cross-sectional lines in FIG. 7A. The structural pattern of the light-emitting area 42 adjacent to the upper edge 34a of the light source 34 can be obtained from the A-A′ cross-sectional line. The structural pattern of the light-emitting area 42 adjacent to the lower edge 34b of the light source 34 can be obtained from the B-B′ cross-sectional line. As shown in FIG. 7B, the light-emitting unit 44 and the light confinement structure 40 are disposed on the substrate 45. As shown in FIGS. 7A and 7B, the width of the light-emitting area 42 adjacent to the upper edge 34a of the light source 34 is W1. The width of the light-emitting area 42 adjacent to the lower edge 34b of the light source 34 is W2. The width W1 is different from the width W2. In accordance with some embodiments, when the display device is a curved display device, the pitch of any two adjacent light-emitting units 44 adjacent to the upper edge 34a may, for example, be greater than the pitch of any two adjacent light-emitting units 44 adjacent to the lower edge 34b. Therefore, the width W1 of the light-emitting area 42 adjacent to the upper edge 34a is greater than the width W2 of the light-emitting area 42 adjacent to the lower edge 34b.

The corresponding relationship between the light-emitting area of the lower backlight module and the pixel unit of the display panel is further illustrated below with reference to FIG. 3.

The light-emitting area of the backlight module includes, for example, a first area, a second area and a third area. The first area has a light-emitting unit and corresponds to at least the first portion P1 of the multiple pixel units of the display panel. The second area has a light-emitting unit and corresponds to at least the second portion P2 of the multiple pixel units of the display panel. The third area has a light-emitting unit and corresponds to at least the third portion P3 of the multiple pixel units of the display panel. In accordance with some embodiments, one light-emitting area can have multiple light-emitting units. In accordance with some embodiments, the number of the first area corresponding to the first portion P1 of the multiple pixel units of the display panel is not limited to one. The number of the first area can be multiple. Similarly, the number of the second area and the number of the third area respectively corresponding to the second portion P2 and the third portion P3 of the multiple pixel units of the display panel may be one or more. In accordance with some embodiments, among the first area corresponding to the first portion P1 of the display panel, the second area corresponding to the second portion P2 of the display panel, and the third area corresponding to the third portion P3 of the display panel, at least two light-emitting areas have different shapes or arrangements. For example, at least the first area and the second area have different shapes or arrangements, at least the first area and the third area have different shapes or arrangements, or at least the second area and the third area have different shapes or arrangements. In accordance with some embodiments, the shape of the first area, the second area, and the third area may include, for example, a parallelogram, a trapezoid, a triangle, or a quadrilateral with at least one arc-shaped edge, but it is not limited thereto.

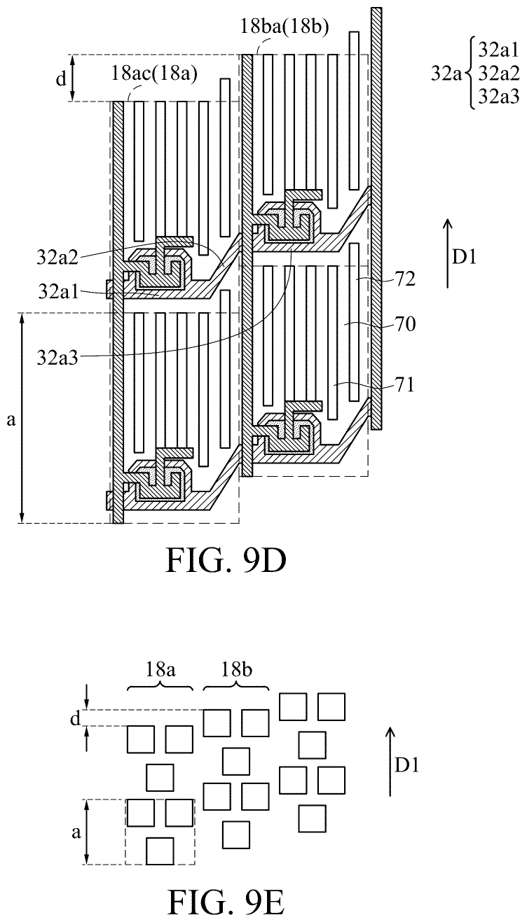

The shape and arrangement of the light-emitting areas of the backlight module will be further described below with reference to FIGS. 8A-8F. For example, each light-emitting area can be in the shape and arrangement of the first area, the second area, or the third area. In the present disclosure, the shapes or arrangements of adjacent light-emitting areas may be different.

As shown in FIG. 8A, the light-emitting area 42 is surrounded by the light confinement structure 40 and has the light-emitting unit 44. Here, the shape of each light-emitting area 42 surrounded by the light confinement structure 40 is a parallelogram. The light-emitting areas 42 are arranged in a partial area in such a manner that the long side L is aligned with the long side L in the vertical direction, and the short side S is aligned with the short side S in the horizontal direction to form a shape as shown in FIG. 8A.

As shown in FIG. 8B, the light-emitting area 42 is surrounded by the light confinement structure 40 and has the light-emitting unit 44. Here, the shape of each light-emitting area 42 surrounded by the light confinement structure 40 is a trapezoid. The light-emitting areas 42 are arranged in a partial area in such a manner that the bottom edge B1 is aligned with the bottom edge B1 and the top edge T1 is aligned with the top edge T1 in the vertical direction, and the side edge S1 is aligned with the side edge S1 in the horizontal direction to form a shape as shown in FIG. 8B.

As shown in FIG. 8C, the light-emitting area 42 is surrounded by the light confinement structure 40 and has the light-emitting unit 44. Here, the shape of each light-emitting area 42 surrounded by the light confinement structure 40 is a triangle. The light-emitting areas 42 are arranged in a partial area in such a manner that the side edge S2 is aligned with the side edge S2 in the horizontal direction, and the bottom edge B2 is aligned with the bottom edge B2 in the vertical direction to form a shape as shown in FIG. 8C.

As shown in FIG. 8D, the light-emitting area 42 is surrounded by the light confinement structure 40 and has the light-emitting unit 44. Here, the shape of each light-emitting area 42 surrounded by the light confinement structure 40 is a trapezoid. The light-emitting areas 42 are arranged in a partial area in such a manner that the top edge T2 is aligned with the bottom edge B3 in the vertical direction, and the side edge S3 is aligned with the side edge S3 in the horizontal direction to form a shape as shown in FIG. 8D. Adjacent light-emitting areas can have different shapes or arrangements. For example, two adjacent light-emitting areas may have different top edge T2 lengths, different bottom edge B3 lengths, or/and different side edge S3 lengths.

As shown in FIG. 8E, the light-emitting area 42 is surrounded by the light confinement structure 40 and has the light-emitting unit 44. Here, the shape of each light-emitting area 42 surrounded by the light confinement structure 40 is a quadrilateral with at least one arc-shaped edge. For example, a fan shape (e.g., a quadrilateral with two corresponding arc-shaped edges and narrow at the bottom and wide at the top). The light-emitting areas 42 are arranged in a partial area in such a manner that the arc-shaped edge R is aligned with the arc-shaped edge R in the vertical direction, and the side edge S4 is aligned with the side edge S4 in the horizontal direction to form a shape as shown in FIG. 8E. Adjacent light-emitting areas can have different shapes or arrangements. For example, two adjacent light-emitting areas may have different arc-shaped edge R lengths, or/and different side edge S4 lengths.

As shown in FIG. 8F, the light-emitting area 42 is surrounded by the light confinement structure 40 and has the light-emitting unit 44. Here, the shape of each light-emitting area 42 surrounded by the light confinement structure 40 is a quadrilateral with at least one arc-shaped edge. For example, a bullet shape (a quadrilateral with a single arc-shaped edge and the same width at the top and bottom). The light-emitting areas 42 are arranged in a partial area in such a manner that the bottom edge B4 is aligned with the bottom edge B4 in the vertical direction, and the side edge S5 is aligned with the side edge S5 in the horizontal direction to form a shape as shown in FIG. 8F.

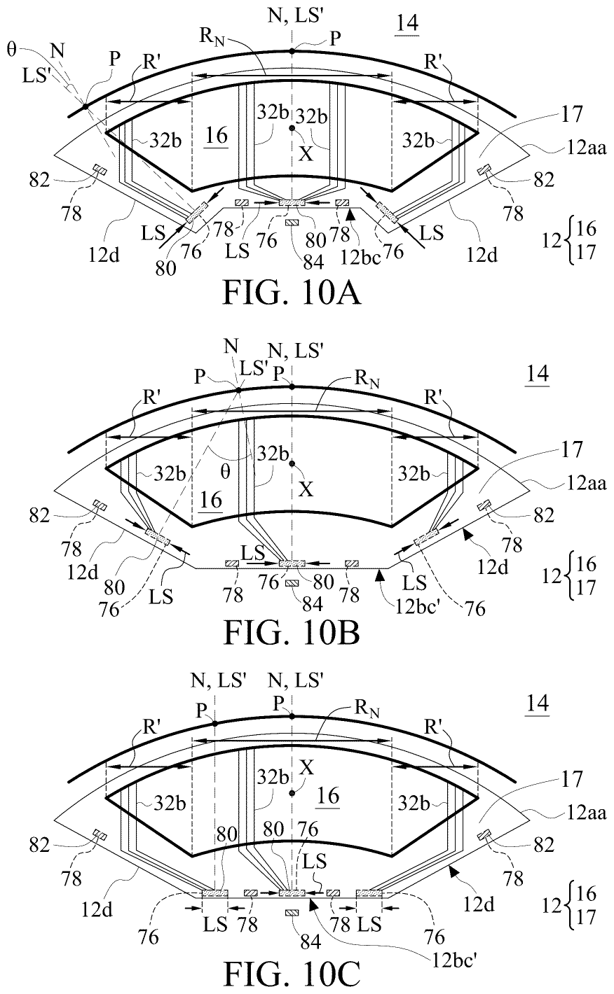

Referring to FIGS. 9A-9D, the arrangement of pixel units and the layout of scan lines are described.

As shown in FIG. 9A, the multiple pixel units in the display area include pixel units 18 located in the first row C1, the second row C2, the third row C3, and the fourth row C4. It is worth noting that the pixel units 18 located in the third row C3 and the fourth row C4 simultaneously generate a displacement distance d in the first direction D1 relative to the pixel units 18 located in the first row C1 and the second row C2. That is, in the embodiment shown in FIG. 9A, the displacement is performed with a plurality of rows (for example, two rows) of the pixel units as one unit. The displacement distance d may be, for example, the shortest displacement distance between the pixel units 18 in the second row C2 and the pixel units 18 in the third row C3. In accordance with some embodiments, the displacement distance d is greater than 0 and less than or equal to the side length a of the pixel, for example, less than or equal to ½, ⅓ or ¼ of the side length a of the pixel, etc. In accordance with some embodiments, the displacement distance d can also be an integer multiple of the side length a of the pixel. In the description, the side length a of the pixel can be defined as the side length of the smallest rectangle that can be enclosed by multiple sub-pixels (e.g., RGB). In accordance with FIG. 9A, the configured scan line 32a may be a stepped scan line. The scan line 32a is used to provide scan signals to the pixel unit. In accordance with some embodiments, the arrangement manner of the pixel units can also be used with curved scan lines, but it is not limited thereto.

As shown in FIG. 9B, the multiple pixel units in the display area include a first pixel unit 18a and a second pixel unit 18b adjacent to the first pixel unit 18a. The first pixel unit 18a and the second pixel unit 18b have a displacement distance d in the first direction D1. The displacement distance d may be, for example, the shortest displacement distance between the first pixel unit 18a and the second pixel unit 18. In accordance with FIG. 9B, the configured scan line 32a may be a curved scan line. When the curved scan line 32a passes through adjacent pixel units, the starting point position entering each pixel unit may be different.

As shown in FIG. 9C, the multiple pixel units in the display area include a first pixel unit 18a and a second pixel unit 18b adjacent to the first pixel unit 18a. The first pixel unit 18a includes a first sub-pixel unit 18aa and a second sub-pixel unit 18ab adjacent to the first sub-pixel unit 18aa. The first sub-pixel unit 18aa and the second sub-pixel unit 18ab have a displacement distance s in the first direction D1. The first pixel unit 18a and the second pixel unit 18b have a displacement distance d in the first direction D1. The displacement distance d may be, for example, the shortest displacement distance between the first pixel unit 18a and the second pixel unit 18b. In accordance with some embodiments, the displacement distance d is different from the displacement distance s, but it is not limited thereto. In accordance with FIG. 9C, the configured scan line 32a may be a curved scan line. In accordance with some embodiments, the arrangement manner of the pixel units can also be used with stepped scan lines, but it is not limited thereto.

As shown in FIG. 9D, the multiple pixel units in the display area include a first pixel unit 18a and a second pixel unit 18b adjacent to the first pixel unit 18a. The sub-pixel unit 18ac of the first pixel unit 18a is adjacent to the sub-pixel unit 18ba of the second pixel unit 18b. The first pixel unit 18a and the second pixel unit 18b generate a displacement distance d in the first direction D1. For example, the displacement distance d is the shortest displacement distance between the sub-pixel unit 18ba of the second pixel unit 18b and the sub-pixel unit 18ac of the first pixel unit 18a. In accordance with some embodiments, the displacement distance d is greater than 0 and less than or equal to the side length a of the pixel, for example, less than or equal to ½, ⅓ or ¼ of the side length a of the pixel, etc. In accordance with some embodiments, the displacement distance d can also be an integer multiple of the side length a of the pixel. In accordance with FIG. 9D, the configured scan line 32a may be a stepped scan line. The scan line 32a includes a first line segment 32a1, a connecting line segment 32a2 and a second line segment 32a3. The first line segment 32al and the connecting line segment 32a2 correspond to the first pixel unit 18a (or the sub-pixel unit 18ac). The second line segment 32a3 corresponds to the second pixel unit 18b (or the sub-pixel unit 18ba). The first line segment 32al is parallel to the second line segment 32a3. The connecting line segment 32a2 connects the first line segment 32al and the second line segment 32a3.

In the embodiment shown in FIG. 9D, an appropriate displacement distance d can avoid the risk of disconnection of the connecting line segment 32a2 due to being too thin, or can avoid the loss of liquid crystal efficiency. In accordance with some embodiments, the slope of the connecting line segment 32a2 may be less than 1. In accordance with some embodiments, the slope of the connecting line segment 32a2 may be less than 1/√3.

In addition, the pixel unit may include a pixel electrode 70. The pixel electrode 70 includes a first slit 71 and a second slit 72 arranged adjacently. Since the scan line 32a presents a stepped layout (for example, the connecting line segment 32a2 is configured with an appropriate slope), the second slit 72 can further extend upward. The extended second slit 72 can not only effectively drive the liquid crystal located in this area, but also fully utilize the aperture ratio.

Referring to FIG. 9E, the arrangement of the pixel units is illustrated.

As shown in FIG. 9E, the multiple pixel units in the display area include a first pixel unit 18a and a second pixel unit 18b adjacent to the first pixel unit 18a. The first pixel unit 18a and the second pixel unit 18b generate a displacement distance d in the first direction D1. The displacement distance d is greater than 0 and less than or equal to the side length a of the pixel, for example, less than or equal to ½, ⅓ or ¼ of the side length a of the pixel, etc. In accordance with some embodiments, the displacement distance d can also be an integer multiple of the side length a of the pixel. In accordance with some embodiments, the arrangement manner of the pixel units can be used with stepped scan lines, curved scan lines or a combination thereof (not shown), but it is not limited thereto.

In accordance with some embodiments, the multiple pixel units in the display area may include at least two pixel unit arrangements in FIGS. 9A-9E, but they are not limited thereto. In accordance with some embodiments, the pixel units illustrated in FIGS. 9A-9D are pixel units of a non-self-luminous display. In accordance with some embodiments, the pixel units illustrated in FIG. 9E are pixel units of a self-luminous display.

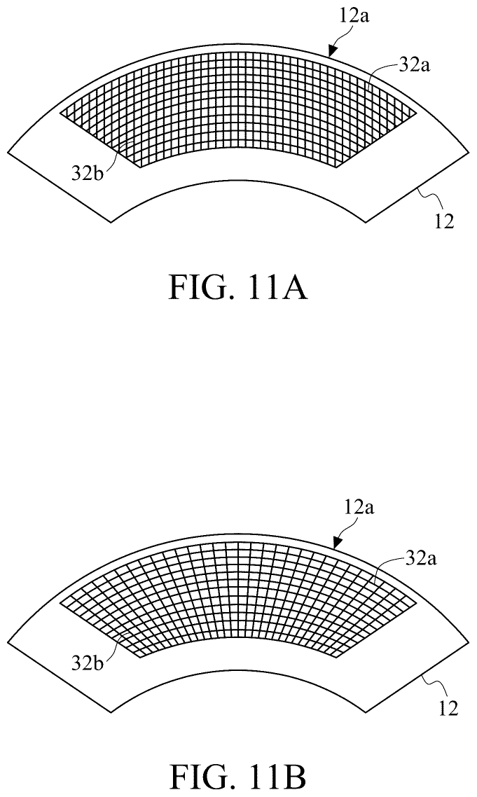

Referring to FIGS. 10A-10C, placement of an electronic unit is illustrated.

As shown in FIGS. 10A-10C, the display panel 12 includes a display area 16 and a peripheral area 17. The peripheral area 17 includes a plurality of first joint portions 76 and a plurality of second joint portions 78. The first joint portion 76 is provided with a first electronic unit 80 connected to data lines 32b. The first electronic unit 80 may include a driver IC, a flexible circuit board (FPC), a printed circuit board (PCB), or a combination thereof. It is worth noting that the number of the pixel units connected to any one data line 32b of the reduced row R′ is smaller than the number of the pixel units connected to any one data line 32b of the normal row R_{N}. For example, the data lines 32b of the normal row R_{N} are data lines electrically connected to the pixel units corresponding to the center X of the display area 16, or other data lines connected to the same number of the pixel units. In accordance with some embodiments, the ratio of the number of the pixel units connected to any one data line 32b of the reduced row R′ to the number of the pixel units connected to any one data line 32b of the normal row R_{N} is less than or equal to 0.9, but it is not limited thereto. The second joint portion 78 is provided with a second electronic unit 82. In accordance with some embodiments, there is a third electronic unit 84 on the backlight module or other electronic module below the display panel 12. The second electronic unit 82 and the third electronic component 84 may include an ambient-light sensor, an infrared-light sensor, an antenna, a dirt detector, a charge-coupled device (CCD) or a chip, etc.

Referring to FIG. 10A, the display panel 12 includes an upper edge 12aa, a lower edge 12bc, and a side edge 12d. The lower edge 12bc corresponds to the upper edge 12aa. The lower edge 12bc is composed of at least two sub-edges or a concave sub-edge, so that the display panel 12 forms a recessed portion. The side edge 12d is adjacent to the upper edge 12aa and the lower edge 12bc. The third electronic unit 84 may be disposed corresponding to the recessed portion. The first electronic unit 80 connected to the reduced row R′ may be disposed on a side of the sub-edge of the lower edge 12bc adjacent to the side edge 12d and substantially parallel to the sub-edge. The normal direction LS′ of the long side LS of the first electronic unit 80 intersects with the edge of the windshield 14 at the intersection point P. The normal direction LS′ of the long side LS of the first electronic unit 80 forms an angle θ with the normal direction N of the edge of the windshield 14. In accordance with some embodiments, the angle θ is less than 45 degrees. The first electronic unit 80 connected to the normal row R_{N} and the first electronic unit 80 connected to the reduced row R′ are placed at a tilt angle relative to each other. In accordance with some embodiments, the tilt angle is less than 60 degrees.

Referring to FIG. 10B, the difference from FIG. 10A is that the lower edge 12bc′ of the display panel 12 is a straight edge. The side edge 12d is adjacent to the upper edge 12aa and lower edge 12bc′. The first electronic unit 80 connected to the reduced row R′ may be disposed on a side adjacent to the side edge 12d and substantially parallel to the side edge 12d. The distance between the first electronic unit 80 connected to the reduced row R′ and the reduced row R′ is smaller than the distance between the first electronic unit 80 connected to the normal row R_{N} and the reduced row R′. Since the first electronic unit 80 connected to the reduced row R′ is disposed adjacent to one side of the side edge 12d and adjacent to the reduced row R′, the distance of the wires can be further reduced, the possibility of wire breakage can be further reduced, and the reliability of the display panel can be improved. In accordance with some embodiments, there is a third electronic unit 84 on the backlight module or other electronic module below the display panel 12. The third electronic unit 84 may be disposed outside the display panel 12. For example, the third electronic unit 84 is disposed not to overlap the display panel 12. The normal direction LS′ of the long side LS of the first electronic unit 80 intersects with the edge of the windshield 14 at the intersection point P. The normal direction LS′ of the long side LS of the first electronic unit 80 forms an angle θ with the normal direction N of the edge of the windshield 14. In accordance with some embodiments, the angle θ is less than 45 degrees. The first electronic unit 80 connected to the normal row R_{N} and the first electronic unit 80 connected to the reduced row R′ are placed at a tilt angle relative to each other. In accordance with some embodiments, the tilt angle is less than 60 degrees.

Referring to FIG. 10C, the locations of the components that are the same as those in FIG. 10B will not be described again here. The difference between the embodiment and FIG. 10B is that the first electronic unit 80 connected to the reduced row R′ can be disposed on a side adjacent to the lower edge 12bc′ and substantially parallel to the lower edge 12bc′. The distance between the first electronic unit 80 connected to the reduced row R′ and the reduced row R′ is smaller than the distance between the first electronic unit 80 connected to the normal row R_{N} and the reduced row R′. The normal direction LS′ of the long side LS of the first electronic unit 80 intersects with the edge of the windshield 14 at the intersection point P. The normal direction LS′ of the long side LS of the first electronic unit 80 forms an angle θ with the normal direction N of the edge of the windshield 14. In accordance with some embodiments, the angle θ is less than 45 degrees. The first electronic unit 80 connected to the normal row R_{N} and the first electronic unit 80 connected to the reduced row R′ are placed at the same placement angle, substantially parallel to the lower edge 12bc′.

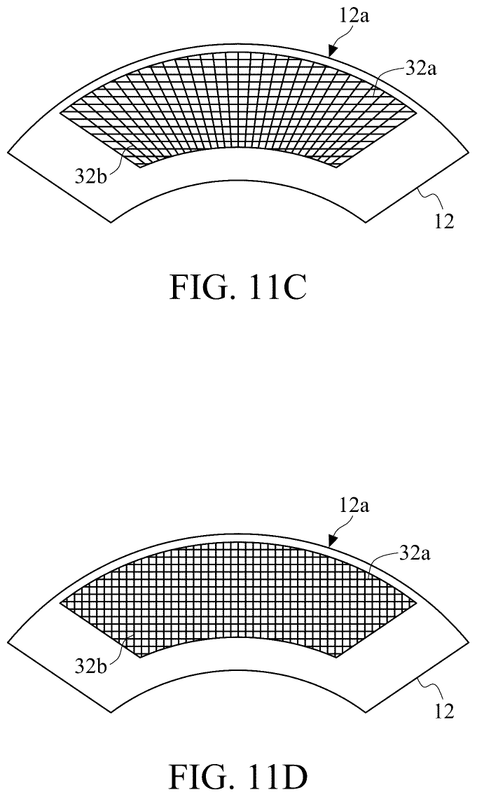

Referring to FIGS. 11A-11D, the configuration of scan lines and data lines is illustrated.

As shown in FIG. 11A, the scan lines 32a are arranged on the display panel 12 in a manner that matches the arc-shaped edge 12a of the display panel 12. The data lines 32b are arranged on the display panel 12 from top to bottom.

As shown in FIG. 11B, the scan lines 32a are arranged on the display panel 12 in a manner that matches the arc-shaped edge 12a of the display panel 12. The data lines 32b are arranged on the display panel 12 at an appropriate angle.

As shown in FIG. 11C, the scan lines 32a are arranged on the display panel 12 from left to right. The data lines 32b are arranged on the display panel 12 at an appropriate angle.

As shown in FIG. 11D, the scan lines 32a are arranged on the display panel 12 from left to right. The data lines 32b are arranged on the display panel 12 from top to bottom.

In the present disclosure, the vehicle display placed under the windshield is made into a curved shape to match the shape of the lower edge of the windshield to improve the utilization of space in the car. Also, the distance projected from each position on the curved display onto the windshield is similar, and this facilitates the subsequent correction of distorted images.

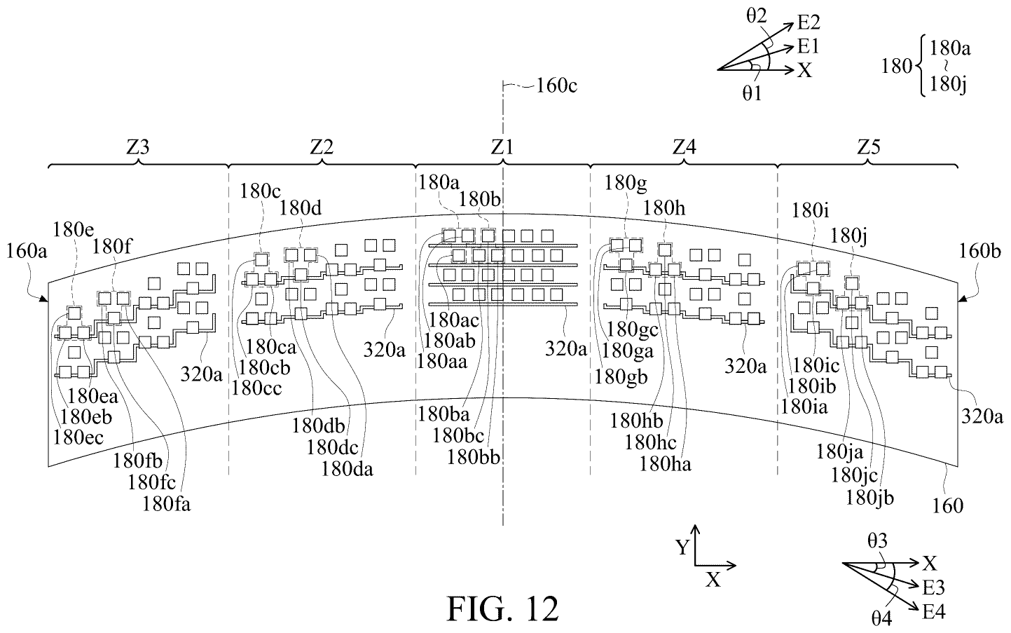

Referring to FIG. 12, pixel unit arrangement with scan line layout in a display area is illustrated.

As shown in FIG. 12, a display area 160 in a display panel (not shown) has a first edge 160a and a second edge 160b corresponding to each other. The display area 160 includes a plurality of zones, for example, a first zone Z1, a second zone Z2, a third zone Z3, a fourth zone Z4, and a fifth zone Z5. The first zone Z1 is located in a center 160c of the display area 160. The third zone Z3 is adjacent to the first edge 160a of the display area 160. The fifth zone Z5 is adjacent to the second edge 160b of the display area 160. The second zone Z2 is located between the first zone Z1 and the third zone Z3. The fourth zone Z4 is located between the first zone Z1 and the fifth zone Z5.

In the first zone Z1, pixel units 180 include, for example, a first pixel unit 180a and a second pixel unit 180b adjacent to the first pixel unit 180a. The first pixel unit 180a includes, for example, a first light-emitting unit 180aa, a second light-emitting unit 180ab, and a third light-emitting unit 180ac. In accordance with some embodiments, the first light-emitting unit 180aa emits red light. The second light-emitting unit 180ab emits green light. The third light-emitting unit 180ac emits blue light. In the first zone Z1, the first light-emitting unit 180aa, the second light-emitting unit 180ab, and the third light-emitting unit 180ac of the first pixel unit 180a are arranged in an inverted triangle. That is, the first light-emitting unit 180aa and the second light-emitting unit 180ab are placed horizontally adjacent to each other and the third light-emitting unit 180ac is located below the first light-emitting unit 180aa and the second light-emitting unit 180ab.

In addition, the second pixel unit 180b includes, for example, a first light-emitting unit 180ba, a second light-emitting unit 180bb, and a third light-emitting unit 180bc. In accordance with some embodiments, the first light-emitting unit 180ba emits red light. The second light-emitting unit 180bb emits green light. The third light-emitting unit 180bc emits blue light. In the first zone Z1, the first light-emitting unit 180ba, the second light-emitting unit 180bb, and the third light-emitting unit 180bc of the second pixel unit 180b are arranged in an equilateral triangle. That is, the first light-emitting unit 180ba and the second light-emitting unit 180bb are placed horizontally adjacent to each other and the third light-emitting unit 180bc is located above the first light-emitting unit 180ba and the second light-emitting unit 180bb.

The first pixel unit 180a and the second pixel unit 180b are staggered along an X direction (ex. a horizontal direction). The first pixel unit 180a and the second pixel unit 180b are arranged along an Y direction (ex. a vertical direction) respectively. Here, the X direction is perpendicular to the Y direction.

In the first zone Z1, the configured scan lines 320a include horizontal scan lines, but they are not limited thereto, and other scan line configurations, for example, stepped scan lines are also applicable to the present disclosure. The scan lines 320a are used to provide scan signals to the pixel units 180.

In the second zone Z2, pixel units 180 include, for example, a third pixel unit 180c and a fourth pixel unit 180d adjacent to the third pixel unit 180c. The third pixel unit 180c includes, for example, a first light-emitting unit 180ca, a second light-emitting unit 180cb, and a third light-emitting unit 180cc. In accordance with some embodiments, the first light-emitting unit 180ca emits red light. The second light-emitting unit 180cb emits green light. The third light-emitting unit 180cc emits blue light. In the second zone Z2, the first light-emitting unit 180ca, the second light-emitting unit 180cb, and the third light-emitting unit 180cc of the third pixel unit 180c are arranged in an equilateral triangle. That is, the first light-emitting unit 180ca and the second light-emitting unit 180cb are placed horizontally adjacent to each other and the third light-emitting unit 180cc is located above the first light-emitting unit 180ca and the second light-emitting unit 180cb.

In addition, the fourth pixel unit 180d includes, for example, a first light-emitting unit 180da, a second light-emitting unit 180db, and a third light-emitting unit 180dc. In accordance with some embodiments, the first light-emitting unit 180da emits red light. The second light-emitting unit 180db emits green light. The third light-emitting unit 180dc emits blue light. In the second zone Z2, the first light-emitting unit 180da, the second light-emitting unit 180db, and the third light-emitting unit 180dc of the fourth pixel unit 180d are arranged in an inverted triangle. That is, the first light-emitting unit 180da and the second light-emitting unit 180db are placed horizontally adjacent to each other and the third light-emitting unit 180dc is located below the first light-emitting unit 180da and the second light-emitting unit 180db.

The third pixel unit 180c and the fourth pixel unit 180d are staggered along a first direction E1. The first direction E1 forms a first angle θ1 with the X direction. In accordance with some embodiments, the first angle θ1 is between 5 and 40 degrees (rotated counterclockwise), with the X direction as 0 degrees. The third pixel unit 180c and the fourth pixel unit 180d are arranged along the Y direction respectively.

In the second zone Z2, the configured scan lines 320a include stepped scan lines extending upward, but they are not limited thereto, and other scan line configurations, for example, curved scan lines are also applicable to the present disclosure. The scan lines 320a are used to provide scan signals to the pixel units 180.

In the third zone Z3, pixel units 180 include, for example, a fifth pixel unit 180e and a sixth pixel unit 180f adjacent to the fifth pixel unit 180e. The fifth pixel unit 180e includes, for example, a first light-emitting unit 180ea, a second light-emitting unit 180eb, and a third light-emitting unit 180ec. In accordance with some embodiments, the first light-emitting unit 180ea emits red light. The second light-emitting unit 180eb emits green light. The third light-emitting unit 180ec emits blue light. In the third zone Z3, the first light-emitting unit 180ea, the second light-emitting unit 180eb, and the third light-emitting unit 180ec of the fifth pixel unit 180e are arranged in an equilateral triangle. That is, the first light-emitting unit 180ea and the second light-emitting unit 180eb are placed horizontally adjacent to each other and the third light-emitting unit 180ec is located above the first light-emitting unit 180ea and the second light-emitting unit 180eb.

In addition, the sixth pixel unit 180f includes, for example, a first light-emitting unit 180fa, a second light-emitting unit 180fb, and a third light-emitting unit 180fc. In accordance with some embodiments, the first light-emitting unit 180fa emits red light. The second light-emitting unit 180fb emits green light. The third light-emitting unit 180fc emits blue light. In the third zone Z3, the first light-emitting unit 180fa, the second light-emitting unit 180fb, and the third light-emitting unit 180fc of the sixth pixel unit 180f are arranged in an inverted triangle. That is, the first light-emitting unit 180fa and the second light-emitting unit 180fb are placed horizontally adjacent to each other and the third light-emitting unit 180fc is located below the first light-emitting unit 180fa and the second light-emitting unit 180fb.

The fifth pixel unit 180e and the sixth pixel unit 180f are staggered along a second direction E2. The second direction E2 forms a second angle θ2 with the X direction. In accordance with some embodiments, the second angle θ2 is between 5 and 40 degrees (rotated counterclockwise), with the X direction as 0 degrees. Here, the second angle θ2 is greater than the first angle θ1. The fifth pixel unit 180e and the sixth pixel unit 180f are arranged along the Y direction respectively.

In the third zone Z3, the configured scan lines 320a include stepped scan lines extending upward, but they are not limited thereto, and other scan line configurations, for example, curved scan lines are also applicable to the present disclosure. Since the scan lines are configured according to the arrangement of pixel units, the steepness of the scan lines 320a in the third zone Z3 is greater than that of the scan lines 320a in the second zone Z2. The scan lines 320a are used to provide scan signals to the pixel units 180.

In the fourth zone Z4, pixel units 180 include, for example, a seventh pixel unit 180g and an eighth pixel unit 180h adjacent to the seventh pixel unit 180g. The seventh pixel unit 180g includes, for example, a first light-emitting unit 180ga, a second light-emitting unit 180gb, and a third light-emitting unit 180gc. In accordance with some embodiments, the first light-emitting unit 180ga emits red light. The second light-emitting unit 180gb emits green light. The third light-emitting unit 180gc emits blue light. In the fourth zone Z4, the first light-emitting unit 180ga, the second light-emitting unit 180gb, and the third light-emitting unit 180gc of the seventh pixel unit 180g are arranged in an inverted triangle. That is, the first light-emitting unit 180ga and the second light-emitting unit 180gb are placed horizontally adjacent to each other and the third light-emitting unit 180gc is located below the first light-emitting unit 180ga and the second light-emitting unit 180gb.

In addition, the eighth pixel unit 180h includes, for example, a first light-emitting unit 180ha, a second light-emitting unit 180hb, and a third light-emitting unit 180hc. In accordance with some embodiments, the first light-emitting unit 180ha emits red light. The second light-emitting unit 180hb emits green light. The third light-emitting unit 180hc emits blue light. In the fourth zone Z4, the first light-emitting unit 180ha, the second light-emitting unit 180hb, and the third light-emitting unit 180hc of the eighth pixel unit 180h are arranged in an equilateral triangle. That is, the first light-emitting unit 180ha and the second light-emitting unit 180hb are placed horizontally adjacent to each other and the third light-emitting unit 180hc is located above the first light-emitting unit 180ha and the second light-emitting unit 180hb.

The seventh pixel unit 180g and the eighth pixel unit 180h are staggered along a third direction E3. The third direction E3 forms a third angle θ3 with the X direction. In accordance with some embodiments, the third angle θ3 is between 5 and 40 degrees (rotated clockwise), with the X direction as 0 degrees. The seventh pixel unit 180g and the eighth pixel unit 180h are arranged along the Y direction respectively.

In the fourth zone Z4, the configured scan lines 320a include stepped scan lines extending downward, but they are not limited thereto, and other scan line configurations, for example, curved scan lines are also applicable to the present disclosure. The scan lines 320a are used to provide scan signals to the pixel units 180.

In the fifth zone Z5, pixel units 180 include, for example, a ninth pixel unit 180i and a tenth pixel unit 180j adjacent to the ninth pixel unit 180i. The ninth pixel unit 180i includes, for example, a first light-emitting unit 180ia, a second light-emitting unit 180ib, and a third light-emitting unit 180ic. In accordance with some embodiments, the first light-emitting unit 180ia emits red light. The second light-emitting unit 180ib emits green light. The third light-emitting unit 180ic emits blue light. In the fifth zone Z5, the first light-emitting unit 180ia, the second light-emitting unit 180ib, and the third light-emitting unit 180ic of the ninth pixel unit 180i are arranged in an inverted triangle. That is, the first light-emitting unit 180ia and the second light-emitting unit 180ib are placed horizontally adjacent to each other and the third light-emitting unit 180ic is located below the first light-emitting unit 180ia and the second light-emitting unit 180ib.

In addition, the tenth pixel unit 180j includes, for example, a first light-emitting unit 180ja, a second light-emitting unit 180jb, and a third light-emitting unit 180jc. In accordance with some embodiments, the first light-emitting unit 180ja emits red light. The second light-emitting unit 180jb emits green light. The third light-emitting unit 180jc emits blue light. In the fifth zone Z5, the first light-emitting unit 180ja, the second light-emitting unit 180jb, and the third light-emitting unit 180jc of the tenth pixel unit 180j are arranged in an equilateral triangle. That is, the first light-emitting unit 180ja and the second light-emitting unit 180jb are placed horizontally adjacent to each other and the third light-emitting unit 180jc is located above the first light-emitting unit 180ja and the second light-emitting unit 180jb.

The ninth pixel unit 180i and the tenth pixel unit 180j are staggered along a fourth direction E4. The fourth direction E4 forms a fourth angle θ4 with the X direction. In accordance with some embodiments, the fourth angle θ4 is between 5 and 40 degrees (rotated clockwise), with the X direction as 0 degrees. Here, the fourth angle θ4 is greater than the third angle θ3. The ninth pixel unit 180i and the tenth pixel unit 180j are arranged along the Y direction respectively.

In the fifth zone Z5, the configured scan lines 320a include stepped scan lines extending downward, but they are not limited thereto, and other scan line configurations, for example, curved scan lines are also applicable to the present disclosure. Since the scan lines are configured according to the arrangement of pixel units, the steepness of the scan lines 320a in the fifth zone Z5 is greater than that of the scan lines 320a in the fourth zone ZA. The scan lines 320a are used to provide scan signals to the pixel units 180.

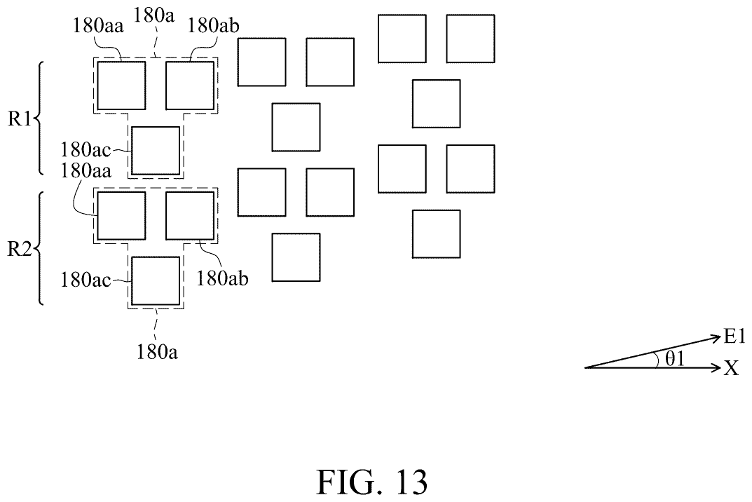

Referring to FIG. 13, another arrangement of the pixel units is illustrated.

The pixel units include, for example, a first row R1 and a second row R2. The first row R1 includes, for example, a plurality of first pixel units 180a. The second row R2 includes, for example, a plurality of first pixel units 180a. The first pixel unit 180a includes, for example, a first light-emitting unit 180aa, a second light-emitting unit 180ab, and a third light-emitting unit 180ac. In accordance with some embodiments, the first light-emitting unit 180aa emits red light. The second light-emitting unit 180ab emits green light. The third light-emitting unit 180ac emits blue light. The first light-emitting unit 180aa, the second light-emitting unit 180ab, and the third light-emitting unit 180ac of the first pixel unit 180a are arranged in an inverted triangle. That is, the first light-emitting unit 180aa and the second light-emitting unit 180ab are placed horizontally adjacent to each other and the third light-emitting unit 180ac is located below the first light-emitting unit 180aa and the second light-emitting unit 180ab.

The first pixel units 180a in the first row R1 and the second row R2 are arranged along a first direction E1. The first direction E1 forms a first angle θ1 with the X direction. In accordance with some embodiments, the first angle θ1 is between 5 and 40 degrees (rotated counterclockwise), with the X direction as 0 degrees. The first pixel units 180a are arranged along the Y direction.

In accordance with some embodiments, the first pixel units 180a in the first row R1 are arranged along the first direction E1. The first pixel units 180a in the second row R2 are arranged along a second direction (not shown). The first direction E1 forms the first angle θ1 with the X direction. In accordance with some embodiments, the first angle θ1 is between 5 and 40 degrees (rotated counterclockwise), with the X direction as 0 degrees. The second direction forms a second angle (not shown) with the X direction. In accordance with some embodiments, the second angle is between 5 and 40 degrees (rotated counterclockwise), with the X direction as 0 degrees. Here, the first angle θ1 is not equal to the second angle. That is, the first direction E1 is not parallel to the second direction.

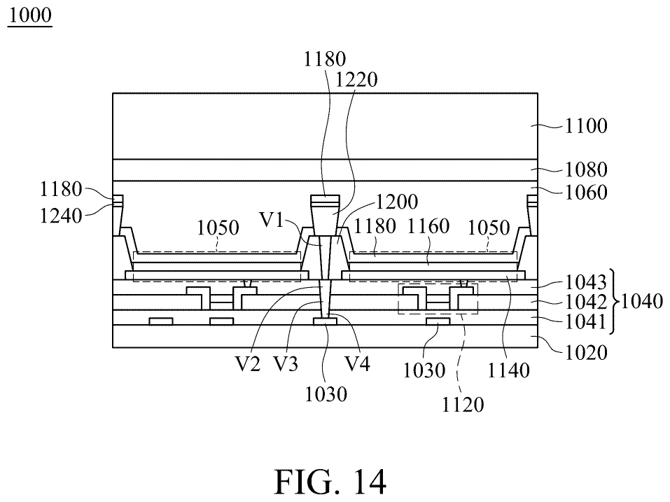

Referring to FIG. 14, in accordance with one embodiment of the present disclosure, a schematic cross-sectional view of a display device 1000 is provided.

As shown in FIG. 14, the display device 1000 includes, for example, a substrate 1020, a plurality of common electrodes 1030, a circuit layer 1040, a plurality of light-emitting units 1050, a plurality of retaining walls 1200, a plurality of protrusion structures 1220, an insulation layer 1060, an intermediate layer (or adhesive layer) 1080, and a cover layer 1100. The common electrodes 1030 are disposed on the substrate 1020. The circuit layer 1040 is disposed on the substrate 1020 and includes thin-film transistors (TFTs) 1120, signal lines, etc., but it is not limited thereto. The circuit layer 1040 includes a first insulating layer 1041, a second insulating layer 1042, and a third insulating layer 1043. The light-emitting units 1050 are disposed on the circuit layer 1040. The light-emitting unit 1050 includes a first electrode 1140, a light-emitting layer 1160, and a second electrode 1180. The thin-film transistor (TFT) 1120 is electrically connected to the first electrode 1140. The retaining wall 1200 is disposed between adjacent light-emitting units 1050. The protrusion structure 1220 is disposed on the retaining wall 1200. In accordance with some embodiments, the protrusion structure 1220 is a conductor. For example, the protrusion structure 1220 connects the common electrode 1030 through a first via V1 (i.e. the perforation of the retaining wall 1200), a second via V2 (i.e. the perforation of the third insulating layer 1043), a third via V3 (i.e. the perforation of the second insulating layer 1042), and a fourth via V4 (i.e. the perforation of the first insulating layer 1041). In addition, a plurality of light-emitting layers 1240 (ex. R/B/G) are left on the protrusion structure 1220. The second electrode 1180 is further disposed on the light-emitting layers 1240. The second electrode 1180 above the light-emitting layers 1240 may be a pixel definition layer (PDL). The second electrode 1180 on the protrusion structure 1220 is not electrically connected to the second electrode 1180 on the retaining wall 1200. The insulation layer 1060 is disposed on the light-emitting units 1050, the retaining walls 1200, and the protrusion structures 1220. The intermediate layer (or adhesive layer) 1080 is disposed on the insulation layer 1060. The cover layer 1100 is disposed on the intermediate layer (or adhesive layer) 1080. In accordance with some embodiments, the display device 1000 may be selectively provided with a light conversion structure and a light-shielding structure. For example, the light conversion structure and the light-shielding structure may be disposed between the intermediate layer (or adhesive layer) 1080 and the cover layer 1100, but they are not limited thereto.

In accordance with the stack structure shown in FIG. 14, the display device 1000 is an organic light-emitting diode display (OLED), but it is not limited thereto. The present disclosure may also be applied to other types of displays, such as a liquid-crystal display (LCD) or a micro light-emitting diode display (micro LED).

Although some embodiments of the present disclosure and their advantages have been described in detail, it should be understood that various changes, substitutions and alterations can be made herein without departing from the spirit and scope of the disclosure as defined by the appended claims. The features of the various embodiments can be used in any combination as long as they do not depart from the spirit and scope of the present disclosure. Moreover, the scope of the present application is not intended to be limited to the particular embodiments of the process, machine, manufacture, composition of matter, means, methods and steps described in the specification. As one of ordinary skill in the art will readily appreciate from the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods or steps. In addition, each claim constitutes an individual embodiment, and the claimed scope of the present disclosure includes the combinations of the claims and embodiments. The scope of protection of present disclosure is subject to the definition of the scope of the appended claims. Any embodiment or claim of the present disclosure does not need to meet all the purposes, advantages, and features disclosed in the present disclosure.

What is claimed is:

1. A display device disposed under a windshield, wherein a bottom of the windshield has a first arc-shaped edge, and the display device comprises:
a display panel to project a display image onto the windshield, wherein the display panel is flat, and the display panel has a second arc-shaped edge adjacent to the first arc-shaped edge,
wherein the first arc-shaped edge has a first radius of curvature, represented by Rs1, the second arc-shaped edge has a second radius of curvature, represented by Rd1, and a ratio of the first radius of curvature to the second radius of curvature is greater than or equal to 0.1 and less than or equal to 10.

2. The display device as claimed in claim 1, wherein the second arc-shaped edge further has a third radius of curvature, represented by Rd2, that is different from the second radius of curvature, and the first radius of curvature, the second radius of curvature and the third radius of curvature comply with formula (I):
$$\vert ( Rs 1 / Rd 1 ) - 1 \vert < \vert ( Rs 1 / Rd 2 ) - 1 \vert . \qquad ( I )$$

3. The display device as claimed in claim 2, wherein the display panel further has a third arc-shaped edge corresponding to the second arc-shaped edge, the third arc-shaped edge has a fourth radius of curvature, represented by Rd3, and the first radius of curvature, the second radius of curvature and the fourth radius of curvature comply with formula (II):
$$\vert ( Rs 1 / Rd 1 ) - 1 \vert ≦ \vert ( Rs 1 / Rd 3 ) - 1 \vert . \qquad ( II )$$

4. The display device as claimed in claim 3, wherein the first arc-shaped edge further has a fifth radius of curvature, represented by Rs2, that is different from the first radius of curvature, and the second radius of curvature, the third radius of curvature and the fifth radius of curvature comply with formula (III):
$$\vert ( Rs 2 / Rd 2 ) - 1 \vert < \vert ( Rs 2 / Rd 1 ) - 1 \vert . \qquad ( III )$$

5. The display device as claimed in claim 4, wherein the third radius of curvature, the fourth radius of curvature and the fifth radius of curvature comply with formula (IV):
$$\vert ( Rs 2 / Rd 2 ) - 1 \vert ≦ \vert ( Rs 2 / Rd 3 ) - 1 \vert . \qquad ( IV )$$

6. The display device as claimed in claim 1, wherein the display panel comprises a display area comprising a plurality of pixel units, the plurality of pixel units comprise a first portion comprising a first pixel unit and a second pixel unit adjacent to the first pixel unit, the first pixel unit and the second pixel unit are adjacent to the second arc-shaped edge having the second radius of curvature, the first pixel unit and the second pixel unit have a first displacement distance in a first direction, and the first displacement distance is greater than 0.

7. The display device as claimed in claim 6, wherein the display panel further comprises scan lines for providing scan signals to the first pixel unit and the second pixel unit, each scan line comprises a first line segment, a connecting line segment and a second line segment, the first line segment and the connecting line segment correspond to the first pixel unit, the second line segment corresponds to the second pixel unit, the first line segment is parallel to the second line segment, and the connecting line segment connects the first line segment and the second line segment.

8. The display device as claimed in claim 6, wherein the display panel further comprises scan lines for providing scan signals to the first pixel unit and the second pixel unit, each scan line is a curved scan line, and starting points of the curved scan lines entering the first pixel unit and the second pixel unit are different.

9. The display device as claimed in claim 6, wherein the second arc-shaped edge further has a third radius of curvature that is different from the second radius of curvature, the plurality of pixel units further comprise a second portion comprising a third pixel unit and a fourth pixel unit adjacent to the third pixel unit, the third pixel unit and the fourth pixel unit are adjacent to the second arc-shaped edge having the third radius of curvature, the third pixel unit and the fourth pixel unit have a second displacement distance in the first direction, and the second displacement distance is different from the first displacement distance.

10. The display device as claimed in claim 9, further comprising a backlight module corresponding to the display panel, wherein the backlight module comprises a plurality of light-emitting areas defined by a range surrounded by a light confinement structure and comprising a first area and a second area, the first area has a first light-emitting unit corresponding to at least the first portion of the plurality of pixel units, the second area has a second light-emitting unit corresponding to at least the second portion of the plurality of pixel units, and the first area and the second area have different shapes.

11. The display device as claimed in claim 10, wherein the light confinement structure comprises a retaining wall, reflective glue, groove, protrusion, low-refractive-index material or other structures with light confinement function.

12. The display device as claimed in claim 10, wherein the first area and the second area comprise a parallelogram, a trapezoid, a triangle or a quadrilateral with at least one arc-shaped edge.

13. The display device as claimed in claim 10, wherein the backlight module further comprises a brightness enhancement film (BEF) with a microstructure disposed above the light-emitting areas.

14. The display device as claimed in claim 13, wherein the backlight module further comprises a diffusion film disposed above the brightness enhancement film (BEF), and the diffusion film has an edge which is formed with a concave structure or a convex structure.

15. The display device as claimed in claim 6, wherein the display panel further has a third arc-shaped edge corresponding to the second arc-shaped edge, the third arc-shaped edge has a fourth radius of curvature, and the second radius of curvature is different from the fourth radius of curvature.

16. The display device as claimed in claim 15, wherein the plurality of pixel units further comprise a third portion comprising a fifth pixel unit and a sixth pixel unit adjacent to the fifth pixel unit, the fifth pixel unit and the sixth pixel unit are adjacent to the third arc-shaped edge having the fourth radius of curvature, the fifth pixel unit and the sixth pixel unit have a third displacement distance in the first direction, and the third displacement distance is different from the first displacement distance.

17. The display device as claimed in claim 16, further comprising a backlight module corresponding to the display panel, wherein the backlight module comprises a plurality of light-emitting areas defined by a range surrounded by a light confinement structure and comprising a first area and a third area, the first area has a first light-emitting unit corresponding to at least the first portion of the plurality of pixel units, the third area has a third light-emitting unit corresponding to at least the third portion of the plurality of pixel units, and the first area and the third area have different shapes.

18. The display device as claimed in claim 1, wherein the display panel comprises a peripheral area comprising a joint portion provided with an electronic unit connected to a data line.

19. The display device as claimed in claim 18, wherein the electronic unit comprises a driver IC, a flexible circuit board (FPC), a printed circuit board (PCB), or a combination thereof.

20. The display device as claimed in claim 18, wherein a normal direction of a long side of the electronic unit forms an angle with a normal direction of the first arc-shaped edge of the windshield, and the angle is less than 45 degrees.
